(19) United States
(12) Patent Application Publication
(10) Pub. No.: US 2023/0385934 A1
(43) Pub. Date: Nov. 30, 2023

(54) Computer-Based Recommendation Method And System With Interface Measuring Risk Aversion Based on Non-Financial Characteristics

(71) Applicant: Parrhesia Corporation, New York, NY (US)

(72) Inventor: Tarun Kumar Jain, New York, NY (US)

(21) Appl. No.: 17/829,157

(22) Filed: May 31, 2022

(51) Int. Cl. G06Q 40/06

(52) U.S. Cl. CPC G06Q 40/06

(57) ABSTRACT

A computer system is providing financial recommendations for investors with preferences for non-financial characteristics, by measuring the dependence of a client's financial risk-aversion on non-financial factors referred to as ‘context specific risk-aversion’, and using the context-specific risk-aversion to compute recommended financial securities for investment. Amongst the non-financial factors (contexts) are those related to the values-based factors, often those relating to the environmental, social, or governance (ESG) performance of corporations. On a client computer system, a user interface is provided that displays a stochastic financial outcome with coincident (fixed or stochastic) non-financial outcome(s) forming a context, and displays an input field where the client user inputs data encoding their degree of acceptance for the outcomes presented thus risk-preference. The client computer system transmits the encoded context specific risk preferences to a communicatively coupled server system. The server associates the received client information with a unique client identifier, combines it with any prior data associated the client identifier, and generates financial investment recommendations that best match the client user's context specific risk preferences.

### BACKGROUND

Values-based investing is the class of investment strategies in which investment decisions take into consideration an investor's preferences for non-financial characteristics (such as ESG scores) of financial securities in addition to the risk-return characteristics of financial securities. Legal theory classifies a value-based investment strategy as either a collateral benefits strategy (in which a motive to obtain better non-financial characteristics of an investment coexists and competes with the motive for risk-adjusted returns) or a risk-return strategy (where obtaining the highest risk-adjusted returns is the sole motive for making a financial investment). Risk-return strategies are currently executed either (a) by using preferred non-financial characteristics only to break ties between portfolios with equivalent performance or (b) by using ESG scores to update views on the distribution of returns of assets. See Schanzenbach, Max Matthew and Sitkoff, Robert H., “Reconciling Fiduciary Duty and Social Conscience: The Law and Economics of ESG Investing by a Trustee” (Feb. 1, 2020). 72 Stanford Law Review 381 (2020), Northwestern Law & Econ Research Paper No. 18-22, Harvard Public Law Working Paper No. 19-50.

### Using ESG Scores in Active Views

Views on the future distribution of asset returns that use non-financial characteristics (such as ESG scores) as factors are most often the result of fundamental analysis by analysts, though recently some algorithms—including machine learning methods—have been used to mine potential relations between ESG scores. See Vincent Margot, Christophe Geissler, Carmine de Franco, and Bruno Monnier, “ESG Investments: Filtering versus Machine Learning Approaches,” Applied Economics and Finance, Redfame publishing, vol. 8(2), pages 1-16, Mar 2021. On one hand, fundamental analysis results in a large spread of estimates, as seen in the variance of ESG ratings between ratings agencies. On the other hand, technical analysis, for example with machine learning discovery, runs significant risks of overfitting available data (thus either providing poor out-of-sample performance) or requiring a higher number of active bets that would increase risk and transaction costs for passive retail or institutional investors. The statistical significance of the relationship between ESG scores and returns has been hotly debated in literature. Most importantly, however, these strategies do not represent investor preferences for non-financial characteristics such as ESG scores. For example, higher governance scores are thought to predict higher returns, and higher social scores predict lower returns (as “sin-stocks” are thought to provide a premium). Therefore, a strategy that uses ESG factors to update views on the returns of assets could result in portfolio allocations that are a worse match for the investor's preferences than an ESG-ignorant strategy.

### All Things Being Equal Strategy

Other strategies for values-based investing involves “tilting” (re-balancing asset allocations in a financial investment such as portfolios so that it tilts the weights towards assets with better non-financial characteristics), and “exclusion” (removing from the pool of assets those that have the worst non-financial characteristics). See for example, United Nations Global Compact “A Practical Guide To ESG Integration for Equity Investing,” 2016. Central to the “tilting” and “exclusion” strategies is the ‘all things being equal’ standard, in which non-financial characteristics (ESG scores) can break ties between financial securities with approximately equal (indistinguishable) expectations for financial performance. Satisfaction of the ‘all things being equal’ standard can often be achieved by minimizing the tracking error of the values-based investment strategy against some benchmark. See Michael Branch, Lisa Goldberg, and Peter Hand, “A Guide to ESG Portfolio Construction,” Aperio Group, 2019. Other ways in which one can justify meeting the ‘all things being equal’ standard is to demonstrate factor level exposure (a smart-beta strategy, i.e. that the tilted portfolio has the same exposure to risk-factors like momentum, quality, etc.), or to demonstrate that the portfolio with exclusion has sufficient diversification as measured by some measure of diversification risk (like the Herfindahl number). Central to these strategies is using some form of benchmark index tracking. Benchmark indices often represent market returns, and hence are permissible investments for fiduciaries. Yet at the same time, these benchmarks have compositions that are suboptimal according to optimization algorithms. Therefore, as opposed to the unique solution of most portfolio optimization algorithms, there are many portfolios that can yield similar returns to the benchmark.

### Existing Strategies for Surveying ESG Preference

Currently, financial advisors use ad hoc methods to survey an investor's preferences for non-financial characteristics of financial investments such as ESG scores. A preference (in singular) is a pairwise relation between two financial investments A and B, in which the investor would unequivocally invest in one over the other. Understanding preferences (plural) means having a generalized model with predictive power over all possible pairwise decisions an investor would make. When it comes to understanding preferences for non-financial characteristics, the most common method is to directly elicit a preference (singular) from an investor between portfolios with different non-financial characteristics. One example of this is to directly ask an investor whether they want a portfolio with a 5% Carbon emissions tilt or a 10% carbon emissions tilt, or to ask whether or not they want a portfolio that excludes firms with over 5% revenue from the sale of firearms and weapons. However, as higher non-financial characteristics (such as ESG scores) are always preferred to lower, such questionnaires are effectively asking investors to pick between portfolio compositions (which has implicit financial implications on diversification and risk) rather than express their strength of their preferences. This method in principle puts the burden on investors to conceptualize the financial implications and risks of their ESG preferences on things like diversification and factor level exposure. As a result, some ESG funds have disclaimers that investing in them requires investors to meet the legal standards of being sophisticated or qualified investors. Another method of surveying preference is to ask whether an investor wants their portfolio to meet a given outcome-based standard, such as carbon neutrality by 2050, or those published by the UN Sustainable Development Group. This method suffers the same problem; the issue is not the desirability of the outcomes being surveyed, but rather that a burden is placed on the investor to understand complex financial risks and limitations associated with an investment strategy.

### Utility Functions and Risk-Aversion

Instead of directly asking investors to express preferences for portfolio compositions, modern portfolio theory posits a functional form for an investor's utility that has a measurable parameter—a scalar risk aversion parameter. A person's risk-aversion describes a person's experimental/behavioral/psychological reluctance to take risk (oppositely, risk-tolerance or willingness to take risk). The risk aversion parameter is a numerical representation of a person's risk aversion that is used in the utility function, and those skilled in the art have devised methods to quantitatively measure the scalar risk-aversion parameter. In general, with a utility function, understanding an investor's preferences means positing a utility function and measuring the relevant parameters in it. This is satisfied when the mathematical function describing the client's preferences satisfies the axioms of Von Neumann—Morgenstern utility. Von Neumann, J., and Morgenstern, O. “Theory of games and economic behavior,” Princeton University Press (1944). In purely financial portfolios, measuring a client's risk-aversion is sufficient to absolve a client from the need to personally compare financial investments with different compositions. Measurement of the risk-aversion is all the financial professional needs to compute and provide financial investment recommendations. As a result, it has become possible to offer client's computer generated financial recommendations through services called robo-advisories (like provided by Wealthfront, Betterment, Vanguard).

### Further Behavioral Studies of Risk-Aversion

Risk aversion has been explored in further in literature. A non-constant risk-aversion was used by Kahneman and Tversky (1979) in the development of prospect theory, wherein the risk-aversion was shown to be dependent on the sign (gain vs loss) of financial outcomes. See Kahneman, Daniel, and Amos Tversky. “Prospect Theory: An Analysis of Decision under Risk.” Econometrica 47, no. 2 (1979): 263-91. A risk-aversion that is dependent on the total wealth accumulated has also been used in literature, for example, to demonstrate that such preferences offer a potential solution to the equity premium puzzle. In other studies, an investor's risk-aversion parameter is modeled as being dependent on an investor's education, profession, marital status, personality, or sentiment towards the economy. See Andrew Grant and Steve Satchell (2019): Investment decisions when utility depends on wealth and other attributes, Quantitative Finance, DOI: 10.1080/14697688.2019.1663903. Though such models may provide some explanatory power for an investor's average risk-aversion they have no implications for modeling an investor's preferences for non-financial characteristics and providing recommendations of financial investments based on those preferences. The standard utility function used in Modern Portfolio Theory cannot account for preferences for non-financial characteristics of assets.

### Consumption Goods Utility Function

Very recently, a utility function to model an investor's preference for non-financial characteristics was posited, in which non-financial characteristics are modeled as consumption goods (i.e. consumption-based preferences, and the primary function used for utility functions with multiple outcomes). In consumption goods model, an investor derives some utility from the non-financial characteristics (gᵢ)of each asset (indexed by i) as described in Equation 1 below. Lubos Pastor, Robert F. Stambaugh, and Lucian A. Taylor, “Sustainable Investing in Equilibrium,” (Jun. 4, 2020). Chicago Booth Research Paper No. 20-12, Fama-Miller Working Paper, Journal of Financial Economics (JFE), Forthcoming, Jacobs Levy Equity Management Center for Quantitative Financial Research Paper. In the utility, u, of Equation 1a below, the first term in the exponent is the standard utility from financial gains, and the second term (starting with b) represents the immediate consumption utility of non-financial characteristics.

u=e^{-WγΣw}^{ᵢ}^{r}^{ᵢ}^{-bΣw}^{ᵢ}^{g}^{ᵢ} (Equation 1a)

u=e^{-WγΣw}^{ᵢ}^{r}^{ᵢ}^{-f(g}^{ᵢ}⁾ (Equation 1b)
where γ is a risk aversion parameter, in practice a positive real number γϵ{0 and R+};
W is the current wealth of the investor;
rᵢ is the financial return of asset i; and
b is a parameter (e.g., a positive integer) determining the trade-off between the non-financial characteristics g and money .
   Deriving consumption goods utility from non-financial characteristics has the benefits of corresponding to rational preferences, is amenable to use in portfolio optimization, and can be used to aggregate investor preferences across multiple non-financial characteristics. However, it has the serious deficiency that the motive for values-based investing corresponds to a collateral benefits strategy where there is direct motivation to trade financial returns for non-financial characteristics. Further, any consumption-based utility, even if represented with a different positive, monotonic function f of non-financial characteristics (such as ESG scores, see Equation 1b above) would still be a collateral benefits strategy.

### SUMMARY

Lacking in the art is an approach that models an investor's preferences for non-financial characteristics as arising from a person's willingness to take financial risks. Lacking in the art also is recognition that there can be a plurality of coexisting motives/behavioral phenomena from which preferences for non-financial characteristics arise, and that precisely structuring elicitation can differentiate and target one motive amongst a plurality. Applicant's technical innovation presents a modulation of risk-aversion as a motive from an investor's preferences for non-financial characteristics may arise. The non-financial characteristics of a financial investment act both as (a) a context that can modulate an investor's risk-aversion and as (b) mathematical variables that determine the numerical value of the risk-aversion parameter. The Applicant provides specification of how to mathematically model an investor's risk-aversion as a multivariable function of non-financial characteristics (the context-specific risk-aversion), and further provides methods and systems to quantitatively measure the risk-aversion parameter's dependence on non-financial characteristics as well as methods and systems to compute recommendations for financial investments based on the context-specific risk-aversion.

A context-specific risk-aversion makes intuitive sense: an individual may be reluctant to invest when the asset does not align with their values (for example for some investors, if the investment yields its revenue predominantly from sale of firearms, gambling, or substances), and may be more willing to invest on a risky asset if it aligns with their values. The following example of investing in a startup company helps clarify that willingness to invest can be understood as a modulation of an investor's risk aversion arising from non-financial characteristics (such as ESG scores) of assets. Investing in startup companies can have risk-adjusted returns as attractive as large cap companies. However, many investors may not have a sufficient appetite for risk (too high a risk-aversion) to invest in startup companies. In some instances, an investor may be more willing to take a risk and seek risk-adjusted returns through startups if that startup aligns with their values. As a concrete example, an investor who see startups as too risky and also cares about climate change may be willing to invest in a cleantech venture capital fund or an electric vehicle startup. Thus, the non-financial characteristics of each asset/financial investment can constitute a context that determines how risk-averse an investor will be when considering investment in a subject financial investment.

The Applicant discloses a mathematical utility function that has a risk-aversion parameter for each asset based on its non-financial characteristics, and methods and systems for quantitatively measuring the context-specific risk-aversion of an investor. During measurement of context-specific risk-aversion, the context should only encode how the non-financial characteristics (such as ESG scores) modulate risk aversion; therefore, best practice is to measure risk-aversion using a hypothetical or idealized investment. Use of real-world investments may induce preferences idiosyncratic to said real-world investment through intangible modulating influences like brand likeability. As used herein, reference to a ‘subject investment’ (with respect to measuring context-specific risk aversion) means a hypothetical investment, an actual investment, and any combination thereof. Having measured a context-specific risk-aversion for an idealized investment as the subject financial investment, a server system can compute the risk-aversion of the client for any real asset whose non-financial characteristics are known. Thus, with such measurement data, and algorithms to approximate the described expected utility, and a computer system that can generate financial investment recommendations that are customized based on the measurement data of one or a plurality of investors. In sum, these systems and methods constitute a new method to provide customized and personalized financial investment recommendations that reflect some of the preferences for non-financial characteristics (such as ESG scores); where said method is neither a collateral benefits strategy, nor requires investor sophistication or qualification.

Despite how intuitive the concept behind Applicant's technical innovation may seem, the problem of values-based investing has not been previously identified as a problem that can be addressed through a modulation of risk-aversion by non-financial characteristics. Those skilled in the art have been trained to treat non-financial characteristics as secondary outcomes/motives of an investment, which resulted only recently in the consumption goods utility model for values-based investing. Careful thinking about the problem reveals that preferences arising from context-specific risk-aversion requires a unique method of measurement that differentiates and disambiguates it from consumption goods utility. Consumption goods utility can be measured by finding a monetary equivalent between the expected returns of assets and their non-financial characteristics. Psychologically, central to consumption goods utility is the hedonic pleasure an investor derives from non-financial characteristics compared to an abstraction of the hedonic pleasure they could derive from their future earnings. Heuristically, one can think of the measurement as being an elicitation over a two-dimensional space of (a) expected returns and (b) non-financial characteristics. In other words, consumption goods utility is about how much (certain/already earned) income one is willing to pay to purchase non-financial characteristics. In contrast, measuring risk-aversion means constructing a measurement system that makes the investor weigh the potential reward against the potential risk, and then input into the system their willingness to take on said financial risks. Risk-aversion is fundamentally a gut level, psychological phenomena that only manifests in the presence of both anticipated returns, and financial risk. More generally, one can say that risk aversion is an attitude towards stochastic financial outcomes or equivalently, variable financial outcomes (consumption goods utility does not require surveying over stochastic/variable financial outcomes). Risk-aversion based preferences for non-financial characteristics cannot be measured without using variable/stochastic financial outcomes. Applicant's innovation recognizes that the investor's attitude towards risk (risk-aversion or inversely risk-tolerance) may be modulated in the presence of non-financial characteristics (such as ESG scores) that the investor may prefer. Put in heuristic terms, the risk aversion in prior art is an elicitation over a two-dimensional space of (a) returns (b) risks, and applicant's innovation is an elicitation from a client-user over a three-dimensional space of (a) returns (a scenario of gain) (b) risks (a scenario of loss) (c) non-financial characteristics. Investors (client-users) are viscerally weighing their attitude towards the potential financial gains and losses, with the non-financial information acting as a determinant in that visceral attitude known as risk-aversion. These insights are reflected in the computer-based methods and systems disclosed herein for quantitatively measuring a client-user's context-specific risk-aversion.

### Recommendations Require Diversification

Traditionally, financial investment recommendations improve or reduce the overall risk in the financial investment by investing in a plurality of underlying securities (diversification). Diversifying a portfolio to minimize idiosyncratic risk was the transformative insight of modern portfolio theory. However, existing methods for diversifying the composition of financial investments assume that investors have the same risk-aversion towards each asset. Applicant's introduction of a context-specific risk-aversion means that an investor would have a different risk-aversion towards each asset in a composite financial investment. For example, start by considering that a context-specific risk-aversion would invest more money in an asset based on a lower risk-aversion; however, doing so may create additional risk in the portfolio, and that might then need to be compensated by investing in other assets. Clearly, it is a more complex problem than diversification with risk-aversion being the same for all assets. The methods and systems disclosed herein teach those in the art how financial investments should be diversified when an investor has different risk-aversion for each asset based on its non-financial characteristics. Having seen and learned the disclosed methods, those in the art will be able to modify more niche and sophisticated methods of diversifying portfolios, some of such methods are recited in the claims.

Embodiments of the present invention provide a computer system comprised of a client system configured to quantitatively measure and transmit from one or more clients (investor-users) the client's context-specific risk-aversion, and a server system that is configured to use these context specific risk-aversions in an algorithm to compute recommendations of financial securities (investments generally). The client system includes a user interface that presents the stochastic financial outcomes of some scenario alongside non-financial characteristics that are specific to that scenario. The client user then performs an action in the user interface that results in the input of data that encodes their preferences for that scenario. The data encoding the risk-aversion, data about the scenario, and a client identifier are then transmitted to a communicatively coupled memory store. The server system stores the received input (transmitted data) in the communicatively coupled memory store. In embodiments, the client system is communicatively coupled to the server system. Then, upon receiving a triggering event, the server system accesses from the communicatively coupled memory store all relevant data associated with the client identifier and computes financial recommendations based on the data. These recommendations are typically then transmitted back to the client system and communicated (for non-limiting example, displayed in text, graphics, multi-media, audio and/or visual, or otherwise rendered as a generated indicator or notification) to the client user. In a preferred embodiment, the recommendations are transmitted to any one or combination of: the client system (client user, investor), and a computer processor of a third-party end-user (such as a broker, financial advisor, financial institution, and the like). The third-party end-user may apply the recommendations to the portfolio of a customer who effectively identifies with the pertinent context-specific risk aversions (the customer being separate and distinct from the client users). The recommendations may be directed to financial investments that are distinct from the subject or scenario investments. In other embodiments, the recommendations are directed to financial investments that include the subject or scenario investments used to measure user context-specific risk aversion.

In embodiments, a computer-based investment recommendation system comprises: a client processor and a data storage feed to a datastore in computer memory. The client processor interactively obtains from an investor-user (individual) context-specific risk-preferences of a hypothetical and/or actual investment (generally, subject investment). In particular, the client processor solicits interactive input from the investor-user in a manner producing quantitative measurement data that encodes the user's risk preferences toward variable financial outcomes of the subject investment and encodes non-financial characteristics serving as contextual information about the subject investment. The data storage feed forwards the produced measurement data from the client processor to a datastore communicatively coupled to receive the measurement data encoding both the user's risk preferences and the contextual information about the subject investment. The datastore holds measurement data of one or more users and their risk aversion and respective contextual information for respective subject investments in a manner enabling computing of one or more financial investment recommendations consistent with the investor-user's context-specific risk preferences.

The client processor includes a graphical user interface that interactively obtains from the investor-user the context-specific risk preferences. The graphical user interface presents information regarding the subject investment's variable financial outcomes alongside the contextual information regarding the non-financial characteristics of the subject investment. Input from the investor-user is in response to the presented information. The quantitative measurement data is produced from the responsive user input to the graphical user interface and encodes both the user's risk preferences toward the subject investment's variable financial outcomes and the contextual information.

The graphical user interface presents to the investor-user the variable financial outcomes as: (a) a scenario of a financial loss alongside a scenario of a financial gain, (b) a non-financial gain or a non-financial loss associated with at least one of the financial loss and the financial gain, or (c) a computed statistic of a loss and a computed statistic of a gain.

The user input may correspond to an amount of money they would be willing to pay to accept the variable financial outcomes of the subject investment.

The graphical user interface may present to the investor-user two subject investments with either or both respective variable financial outcomes or non-financial characteristics being different, and the responsive user input is indicative of the investor-user's preference between the two subject investments.

The graphical user interface displays benchmarking information, for non-limiting example, alongside an input field receiving the user input. The benchmarking information includes any one or combination of: (a) data from a previous input from the investor-user, (b) a value representation of the user input corresponding to certain goals or targets being met, (c) indications of the context-specific risk-aversion of other individuals in similar contexts, and (d) information revealed to the investor-user following input that represents the completion of an anticipated event such as the outcome of a bidding process, and the like.

In embodiments, the data storage feed is coupled between the client processor and a server computer. The server computer is coupled to receive from the data storage feed the measurement data from the client processor. The server computer stores the received measurement data in the datastore. The server computer uses the measurement data and computes the one or more financial investment recommendations consistent with the investor-user's context-specific risk aversion. One or more end-user processors receive from the server computer the computed financial investment recommendations which are indicative of relationships between one or more client processor users (investor-users) and their context-specific risk aversions. The one or more end-user processors are run and operated by third party end-users such as brokers, financial advisors, financial institutions, service or investment providers to the investor-user, and the like for non-limiting example. The one or more end-user processors receive the computed financial investment recommendations in a manner enabling or supporting execution of a purchase of one of the recommended financial investments on behalf of the investor-user, or on behalf of a person who effectively identifies with the investor-user's context-specific risk aversion (i.e., identifies with the context-specific risk aversions on which the computed recommendations are based). The person who effectively identifies with the investor-user's context-specific risk aversion may be separate and distinct from each user in the one or more users of the measurement data in the datastore. In embodiments, the client processor may receive from the server computer the computed financial investment recommendations and displays the recommendations in the graphical user interface to the investor-user.

The computed one or more financial investment recommendations may comprise any one or combination of:
a) a ranking/ordering of existing financial investments based on the measurement data of the one or more users;
b) the composition of a financial index for the one or more users comprising information encoding percentages allocations to invest in a plurality of underlying financial assets/securities including but not limited to stocks, bonds, real-estate, commodities, options, futures, derivatives, and exchange traded funds based on the measurement data of the one or more users;
c) the composition of an investment vehicle in which multiple investors share the same asset allocations, such as a mutual fund, an exchange traded fund, or a pension fund plan, comprising information encoding percentages allocations to invest in a plurality of underlying financial assets/securities including but not limited to stocks, bonds, real-estate, commodities, options, futures, and derivatives based upon the measurement data of the one or more users;
d) a benchmark interest rate index that specifies the interest rate at which monies should be lent to a party based on the non-financial characteristics of said party;
e) a vote on a proposal regarding a management decision in a shareholder meeting; and
f) a recommendation on an investment decision taken by corporate management.

In embodiments, the computer-based recommendation system further comprises a transaction mechanism communicatively coupled to the client processor or the server computer enabling execution of a purchase of one of the recommended financial investments on behalf of the investor-user or on behalf of the person who effectively identifies with the same context-specific risk aversion.

The server computer computes the one or more financial investment recommendations using an algorithm with any one or a combination of the following terms: the mean financial return of the portfolio, including factor-based decompositions thereof; terms that are quadratic in variances or covariances of the financial returns, each of which are multiplied by a context specific risk-aversion factor; terms that regularize the variances or covariances such as shrinkage, or Rao's entropy; terms that regularize the variances or covariances that have a bias term that depends on the context-specific risk-aversion factor in a financial investment; an entropic term (such as a Shannon entropy) that is modified by the context-specific risk-aversion factor; worst-case risk-measures, such as variance at risk or conditional variance at risk that are modified by the context-specific risk-aversion factor; forms of Risk-parity, risk-budgeting, or hierarchical risk-budgeting that are modified based on the context-specific risk-aversion factor; terms that account for transaction costs of updating the weights of a financial investment; and terms that account for market impact costs when updating the weights of a financial investment.

In embodiments, the computer-based recommendation system updates, rebalances, or otherwise changes the one or more financial investment recommendations over time, including in response to: additional preference data transmitted by the client processor through the data storage feed; changes in environmental, social, or governance (ESG) ratings data; changes in market prices; passage of a predefined or fixed time interval; news events; and computer analysis of a time varying input data source.

In embodiments, the subject investment may be any of: a hypothetical investment, an actual investment, and a combination of hypothetical and actual investments. The computed one or more recommendations may be directed to financial investments that are distinct from the subject investments. In other embodiments, the computed recommendations are directed to financial investments that include the subject investment.

In embodiments, the datastore supports various types of data in conjunction with the quantitative measurement data of the one or more users to generate financial investment recommendations. The various types of data include any one or combination of:
asset price distribution data, where the distribution data encodes information about the probability distribution of asset prices;
non-financial characteristics data, where said data encodes information about the historical, present, or future expected values or probability distributions of non-financial characteristics of assets that the financial investment is to be composed of;
future distribution data, where the future distribution data encodes information about future distribution of asset prices or about future distribution of non-financial characteristics;
alternative data sources, such as expert views, proprietary data, news data or sentiment analysis data;
constraint data, where constraint data encodes information about what constraints are to be imposed upon the optimization problem;
benchmark data, where benchmark data encodes a reference for what assets can be considered as part of the financial investment and/or a reference for the asset allocation of the financial investment;
hyperparameter data, including parameters used for regularizing asset price distributions, for handling transaction; and
machine learning model data, where the server employs a neural network to compute any financial investment recommendation.

In other embodiments, a computer-implemented recommendation system that matches individuals with financial investments, comprises: a datastore in computer memory, and a server computer. The datastore holds or stores quantitative measurement data of one or more users. For each user, the quantitative measurement data of the user encodes both (a) risk aversion of the user toward variable financial outcomes of a respective subject investment, and (b) non-financial characteristics serving as contextual information about the subject investment. The quantitative measurement data is produced from interactive user input with respect to the subject investment. For different users, the datastore holds measurement data encoding the user's risk aversion with respective contextual information of different subject investments. The server computer is coupled to access the datastore, and uses the quantitative measurement data of the one or more users to compute for an investor-user one or more financial investment recommendations consistent with the investor-user's context-specific risk aversion. The server computer supports transmission of the computed one or more financial investment recommendations in a manner enabling display of the same to any one or combination of the investor-user (i.e., one of the one or more users) and other end-users (brokers, financial institutions, financial advisors, service or investment providers to the one investor-user, and the like for non-limiting example).

In a preferred embodiment, the server accesses the datastore and uses the quantitative measurement data of the one or more users to compute one or more financial investment recommendations consistent with a part of the one or more users' context-specific risk aversions. The server computer supports transmission of the computed one or more financial investment recommendations in a manner enabling execution of a purchase of one of the recommended financial investments (in the computed one or more financial investment recommendations) on behalf of one user (an investor-user) of the one or more users, or on behalf of a person who effectively identifies with the context-specific risk aversions supporting the computed recommendations. The person is distinct from the one or more users having quantitative measurement data stored in the datastore.

The recommendation system may further comprise a data source feed between the datastore and a client processor. The client processor has a graphical user interface that interactively obtains, from the one investor-user, context-specific risk aversion of the respective subject investment. In particular, the user interface solicits input from the investor-user in a manner producing the quantitative measurement data. The data source feed carries the produced quantitative measurement data from the client processor to the datastore for storage.

In embodiments, the graphical user interface presents to the one investor-user information regarding the subject investment's variable financial outcomes alongside or otherwise associated with the contextual information regarding the non-financial characteristics of the subject investment. The user input is by the investor-user responding to the graphical user interface presented information. The subject investment may be hypothetical, actual, or a combination thereof.

In the server computer's computations, the risk-aversion of the one user (investor-user) is encoded as a non-constant risk-aversion function of one or multiple non-financial variables that can be mapped to (i) a numerical value for any single financial asset, and (ii) a numerical value for a subset or group of financial assets that is used as a constituent in a candidate financial investment for recommendation.

The server computer computes numerical values of the risk-aversion function from data on non-financial performances of the underlying assets in addition to the quantitative measurement data held in the datastore. The computed one or more financial investment recommendations may focus on the subject investments used to produce the quantitative measurement data in the datastore or may focus on separate and distinct investments.

In an embodiment, the other end-users include a service provider or investment provider to the one investor-user, or the like. An end-user processor of the service provider is coupled to receive from the server computer the computed one or more financial investment recommendations for the one investor-user. The end-user processor may automatically or responsively execute a purchase of one of the recommended financial investments on behalf of the one investor-user. Known or common transaction systems may be employed to accomplish the purchase.

In embodiments, the server computer further supports transmission of the computed one or more financial investment recommendations in a manner enabling a financial institution to update an investment portfolio.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of the interface and contents therein of a client system that receives input of an individual's context specific risk-aversion.

FIG. 2 is a schematic view of the interface (screen views and content) of an embodiment of the client system that uses a lottery type question for quantitatively measuring an individual's context-specific risk-aversion.

FIG. 3 illustrates the interface (screen views and content) of an embodiment of the client system that uses solicitation of a preference between two lotteries (both of which have variable financial outcomes) to elicit user input encoding an individual's context specific risk-aversion.

FIG. 4 is a logic diagram of the system logic that controls the sequence of user interface screen views and contents to measure context-specific risk-aversion over the multiple non-financial characteristics (variables) and a sufficient range of values that those variables can take in embodiments.

FIG. 5 is a flow diagram of an algorithm or server logic used to compute financial investment recommendations for a client investor-user in embodiments.

FIG. 6 is a schematic view of the financial investment recommendations as provided to a client system for rendering in a user interface (i.e., to the client investor-user and/or other end users), specifically when making a recommendation between pre-existing financial investments such as exchange traded funds (ETFs) for different asset classes and geographic regions in embodiments.

FIG. 7 is a schematic view of a computer network in which embodiments of the present invention may be deployed.

FIG. 8 is a block diagram of a computer node (client, server) in the computer network of FIG. 7.

### DETAILED DESCRIPTION

A description of example embodiments follows.

The teachings of all patents, published applications and references cited herein are incorporated by reference in their entirety.

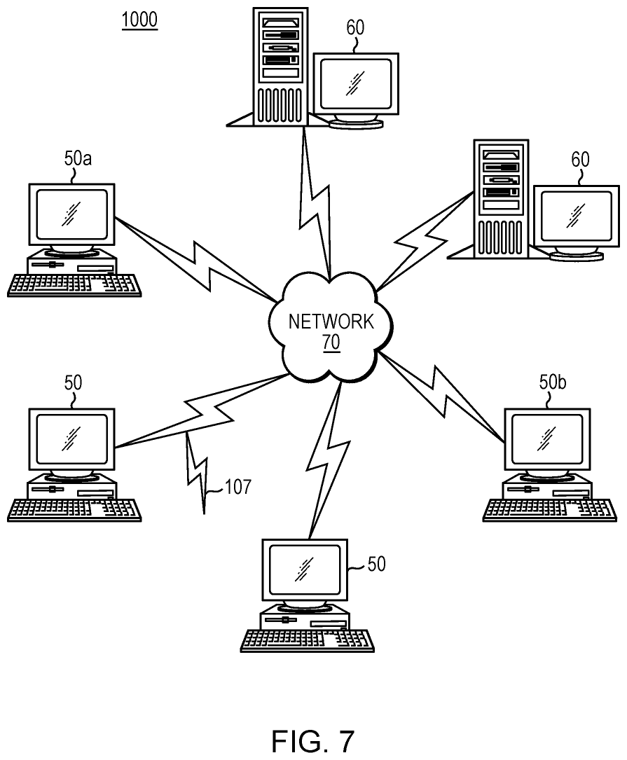

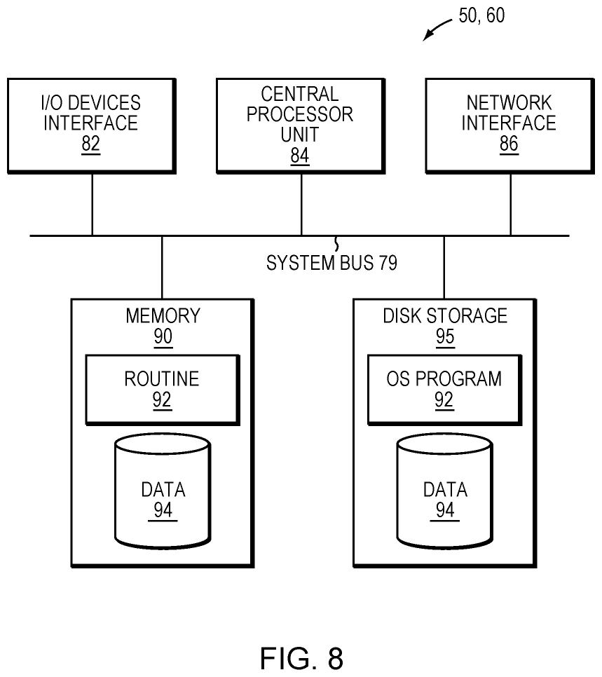

A computer system 1000 (FIGS. 7 and 8) is described for providing financial investment recommendations based on measurement data of the dependence of risk-aversion on the non-financial characteristics of financial investments of one or more client-users. In some embodiments, the computer system 1000 is used to reflect client user(s)' preferences for Environmental, Social, and Governance (ESG) related aspects of the performance of the underlying assets in composite financial investments.

The computer system 1000 provides a client system 50 (50a, 50b, 50 generally, FIGS. 7 and 8) that directly measures how an asset's non-financial characteristics affect the client's (an individual, or client-side investor user) risk-aversion for a subject financial investment. In a client interface, this dependence is called a context-specific risk-aversion because the non-financial characteristics form a specific context for the user interaction that mediates the client's input. The most direct way of quantitatively measuring an individual's risk aversion is to solicit information from a user that encodes how much money they expect to be compensated in order to accept an uncertain financial outcome instead of a certain payoff (called a risk-premium). From any given utility function, a person skilled in the art can derive a mathematical relationship between the risk-premium and the risk-aversion parameter in the utility function, the risk-aversion parameter being a numerical representation of a client's cognitive/behavioral risk-aversion. A server computer 60 (FIGS. 7 and 8) can use measurements of a client's context-specific risk-aversion to approximate a mathematical function mapping from non-financial characteristics to a risk-aversion value, and thereby automate evaluating the numerical values of the client user's context-specific risk-aversion for the specific non-financial characteristics of each of the assets comprising a candidate financial investment (actual, e.g., market available). Thereafter, the server computer 60 can responsively generate one or more financial investment recommendations.

The subject financial investment used in the client interface to measure context-specific risk aversion of investor-users may be hypothetical investments, actual investments, or a combination thereof. The subject financial investments may be an actual investment that is a focus of the recommendations or may be other actual investments separate and distinct from the financial investments named in the recommendations.

In embodiments, a computer-based recommendation system 1000 provides financial investment recommendations to various client side 50 users, e.g., the client system 50a investor-user (individual) and third party processor 50b end-users (brokers, financial advisors, financial institutions, service or investment providers to the client investor-user, and the like). Financial investment recommendations in this context are understood to be computed based on the measurement data of context-specific risk-aversion of one or more client 50a investor-users. The recommendation system comprises: one or more client processors 50 (generally, e.g., 50a, 50b) and a data storage feed 86 (FIG. 8). As will be made clear below, the client processors 50, 50a interactively obtains from one or more client investor-users context-specific risk-aversion preferences of respective subject investments. In particular, per client investor-user, the client processor 50, 50a via a graphical user interface for non-limiting example, solicits interactive input from the user in a manner producing quantitative measurement data. The produced measurement data encodes (i) the user's risk-aversion toward variable financial outcomes of the subject investment displayed or referenced in the graphical user interface, and encodes (ii) non-financial characteristics serving as contextual information about the subject investment. The graphical user interface displays or references different subject investments for different client investor-users or for different user sessions.

The data storage feed 86 forwards, outputs, or otherwise links the produced measurement data of the client investor-users from the client processors 50, 50a to a datastore 94 in computer memory 90 of a server 60. The data storage feed 86 follows network communications and other protocols common in the art. The datastore 94 is communicatively coupled to receive the measurement data encoding both the user's risk-aversion and the contextual information specific to that value. The data store 94 may index or otherwise arrange storage of the received measurement data by a client user identifier which is unique for each client investor-user and is included in the data transmission across data storage feed 86. The datastore 94 holds the measurement data of the one or more client investor-users (including the users' risk-aversions and respective contextual information for subject investments) in a manner enabling computing for a given investor-user one or more financial investment recommendations consistent with the one or more investor-users context-specific risk aversions.

In embodiments, the data storage feed 86 is coupled between the client processors 50, 50a and a server computer 60. The server computer 60 is coupled to receive from the data storage feed 86 the measurement data of client investor-users from client processors 50, 50a. The server computer 60 stores the received measurement data in the datastore 94, and the server computer 60 computes for a given investor-user (of the one or more client investor-users, or distinct therefrom) the one or more financial investment recommendations consistent with the context-specific risk-aversion of the one or more client investor-users as detailed further below. In turn, client-side processors 50 (generally), that is, any one or combination of the given investor-user's client processor 50a and other end-user processors 50b receive from the server computer 60 the computed one or more financial investment recommendations for the given investor-user based on the stored measurement data of the one or more client investor-users' context-specific risk-aversions of datastore 94. In some embodiments, the end-user processor 50b (50 generally) can then execute financial transactions on behalf of the given client investor-user and/or on behalf of plural client investor-users based upon the financial investment recommendations received from the server computer 60. In other embodiments, the end-user processor 50b can responsively display received relationship information (regarding relationships between client investor-users and their context-specific risk aversions) in a graphical user interface to the end-user and displays the received one or more financial investment recommendations to the end-user. As non-limiting examples, the end user may be: (i) an institutional investment provider providing a financial product to a plurality of the client investor-users or other interested individuals, (ii) an investment advisor/professional recommending investments to an individual (who may or may not be a client investor-user), or (iii) a retail investor investing through a brokerage firm. The advisor/investment provider end-user may apply the received financial investment recommendations to a customer (individual) who was not one of the client investor-users of client processors 50a but who effectively identifies with the measured context-specific risk aversions of the client investor-users. Further the advisor/investment provider end-user may implement one or more of the recommendations on behalf of a client investor-user or individual utilizing existing investment purchasing or transaction mechanisms as further detailed below.

The one or more financial investment recommendations may involve a plurality of underlying actual assets or securities, including but not limited to stocks, bonds, real-estate, commodities, derivatives, options, futures, bond funds, exchange traded funds, mutual funds, or pension funds. In embodiments, the one or more financial investment recommendations may focus on investments distinct from the subject investments used in the client interface for producing the context-specific risk aversion measurements. In other embodiments, the investment recommendations are with respect to and include the subject investments from the client interface.

The client processor 50a of the given investor user may display, in the graphical user interface for non-limiting example, the one or more financial investment recommendations computed by and received from server computer 60. Additionally, in embodiments the server computer 60 executes, or transmits to another computer system (common or known in the industry) to execute, purchase of one of the recommended financial investments on behalf of the given investor-user in response to user command. For non-limiting example, the given investor-user reviewing the financial investment recommendations on the client processor 50a (50 generally) may further respond to the displayed recommendations, and the graphical user interface may be configured to take orders for an investment purchase. The client processor 50a (50 generally) relays such client investor-user orders to the server computer 60 to implement the purchase. Common or known investment transaction systems may be employed to make the purchase.

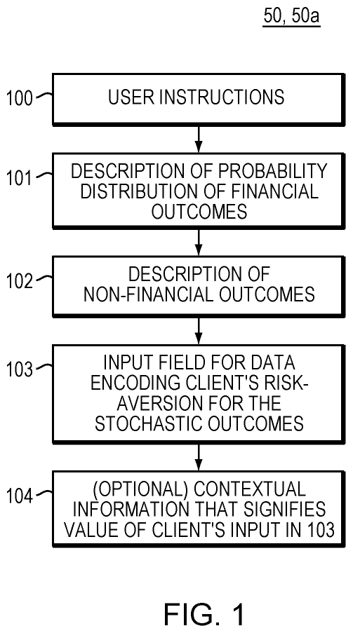

Turning now to FIG. 1. FIG. 1 provides a basic structure for the sequence of screen views or contents therein in a user interactive interface presented on a client system 50 (such as given investor-user client processor 50a for non-limiting example) to measure the client user's (individual's/investor's) context-specific risk-aversion in embodiments. For a given investment (hypothetical, actual, or a combination thereof), some information about the financial outcomes and the probability of their occurrence is presented in 101 and is presented alongside information about the non-financial characteristics 102 of the given investment. An element 103 in a screen view of the interface is then configured to receive an input (response) from the client user. The instructions 100, method, and type of input received from the user determines the way in which the user's context-specific risk-aversion is encoded by the received input data. In some embodiments, the client user is presented with additional benchmarking information 104. Best use has benchmarking information provided after elicitation of context-specific risk aversion, as it is intended to help client investor-user post-facto understand the implications preference beyond their immediate input (for example, explaining how elicited risk-aversion affects overall portfolio ESG score). In some cases, benchmarking information should not be presented in a manner that modulates elicitation of risk-preferences (otherwise, it would be classified as additional contextual information and must be treated by the computer system 1000 accordingly. In some embodiments, benchmarking information presents input previously input by the investor-user to facilitate temporally consistency in elicitation of context-specific risk-aversion. In other cases, benchmarking information is used to reveal information anticipated by the investor-user based on the instructions 100 about the interactive input, as is often required by auction type questions. For non-limiting example, if the case where the instructions 100 tell the client investor-user that the interactive input is a competitive bid in an auction, then the benchmarking information could reveal to the client investor-user the result of the bidding process.

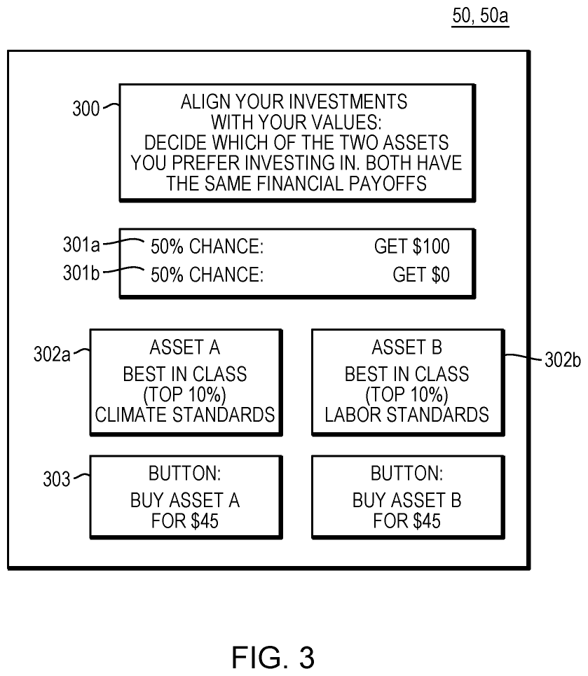

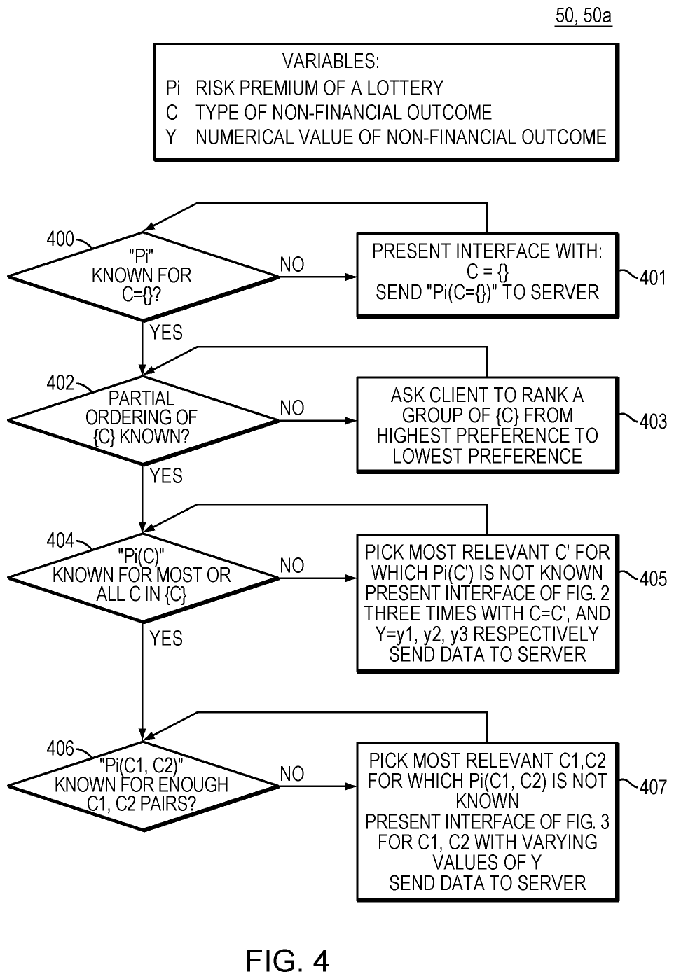

FIG. 2 illustrates an embodiment in which the interface of the client system 50 (e.g., investor-user client processor 50a) presents the client user with a lottery type question. After giving the client user relevant financial 201a, 201b and non-financial 202 contextual information about the subject investment (which may be a hypothetical investment, an actual investment, or a combination thereof), the client user is asked to input data into a numerical input field 203 and instructed 200 to move a slider whose value is bound to a numerical display on the client user interface. From the instructions 200, the client user understands that the numerical display corresponds to the amount of money they would be willing to buy the asset (lottery) for, i.e., known as the expected returns minus the risk-premium. This risk-premium in turn can be used to create a mapping from the non-financial characteristics of an asset to a numerical risk-aversion value, where said mapping is based on a relationship that can be analytically derived (i.e. a relationship found from the equation for the utility function). In other embodiments, the variable financial outcome can be presented as a subject investment with (a) a given value-at-risk (a term of art for an approximation of the maximum losses of an investment), (b) some expected returns, and (c) non-financial characteristics as context. The investor-user input can then be the risk-premium for buying the subject investment. A relationship between the risk-premium, the value-at-risk, and the risk-aversion parameter can again be derived analytically or computed algorithmically for a given utility function and distribution of financial outcomes of the subject investment. In other embodiments, the investor-user can be asked to input what short-term losses (value-at-risk) they are willing to tolerate for a subject investment's expected returns.

In the art of experimental economics, one main concern is that the information elicited from a client investor-user is close to some ground truth (i.e. that in a willingness to pay experiment, the elicited response is actually what the client investor-user may pay in real life). Based on this concern, a variety of techniques have been developed; a non-limiting example Becker-DeGroot-Marscak and Vickrey auctions to measure willingness to pay. A person skilled in the art, having read Applicant's disclosure, would be able to modify the user interfaces described in the figures and herein to accommodate other experimental methods from economics literature. An ideal place for many of such modifications is in the instructions (100 in FIGS. 1, and 200 in FIG. 2) combined with benchmarking information (104 in FIG. 1, 204 in FIG. 2); all other elements in the interfaces are still required as presented to measure a context-specific risk-aversion.

FIG. 3 presents another user interactive interface useable in embodiments at client processor 50, 50a for quantitatively measuring a client's (investor-user's) context specific risk-preferences. In a screen view of the user interface, the client interface presents financial information 301a and 301b common to Asset A and Asset B, and different non-financial characteristics 302a, 302b that are specific to Asset A and Asset B respectively. Asset A and Asset B are hypothetical investments, actual investments, or a combination thereof. Together, 301a,b and 302a,b represent the information for a lottery with non-financial characteristics 302a for Asset A and a lottery with non-financial characteristics 302b for Asset B. The screen view includes an introduction 300 for context to the client user (investor-user). The client interface asks the user to press a button 303 to indicate which of the two lotteries they would prefer given the price of each lottery. This is often used when 302a and 302b are different non-financial characteristics, for example, climate change and gender diversity.

A person skilled in the art would understand that the present invention is not limited to the specific screen views and example content in user interfaces of FIGS. 1 through 3. Further, the non-financial information presented can be presented in a wide variety of ways. For non-limiting example, non-financial contextual information on carbon dioxide (CO₂) emissions could be presented as absolute CO₂ emissions, CO₂ emissions divided by revenue, percentile of CO₂ emissions compared relative to all assets, percentile CO₂ emissions relative to assets that are in the same industry (or that have a similar correlation or similar factor exposure), absolute CO₂ emissions relative to some theoretical limit for the goods produced by the company, or even whether CO₂ emissions of a company are either setback or further progress on some future outcome. In embodiments, a measured value of risk-aversion is specific to precise context and the way in which the contextual information is presented. Should the system seek to obtain consistency across methods of presentation of non-financial characteristics (such as CO₂ in the example above), the optional benchmark information from 104 is ideally suited to facilitating a client-user's comparison and consistency across methods of presentation. Furthermore, risk-preferences over multiple non-financial variables can be measured by presenting information on multiple parameters in the same interface.

Explicit in embodiments of the present invention, is the measuring of the one or more investor-user's context-specific risk-aversion over many instances or sessions of the user interface in FIGS. 1, 2 and 3. Measuring the investor-user's preferences across multiple instances of and multiple subject investments allows for a more extensive parametrization of the one or more investor-user's context-specific risk-aversions. FIG. 4 provides a simple embodiment for the logic by which the client system 50, 50a can present a series of screen views to the client user. First, the client system 50 sends a client identifier to the server system 60 (FIGS. 7 and 8) and retrieves or confirms from the server system the latest data on what context-specific risk-aversions are already stored. In the case that client user is using multiple client computer devices 50, storing this data on a first client computer system is not enough. Thus, embodiments store the data on server system 60 or datastore 94 indexed by client identifier. Then, if data on the client investor-user's risk-aversion for a non-financial characteristic is not available or incomplete 400, the client system 50, 50a presents a screen view 401 in the user interface in which that data is solicited from the user. Next, the client system 50, 50a checks whether a full or partial ordering 402 of the investor-user's preferences for non-financial characteristics is possible with the available data. If not, client system 50, 50a presents to the investor user a screen view in the interface in which they are asked to rank the non-financial categories based on how much they care about them 403. Thereafter, the client system 50, 50a checks whether the risk-premium has been sufficiently measured for each of the non-financial characteristics that act as variables for context specific risk-aversion 404. If not, then client system 50, 50a presents a series of screen views in which that missing data is solicited (starting with the non-financial categories that the user cares most about) 405. Finally, the client interface checks 406 whether it has sufficient data to estimate the risk-premium in the presence of concurrent information on multiple non-financial variables. If not, the client system 50, 50a presents the client investor-user with a series of binary lotteries 407 to obtain that data. The logic diagram of FIG. 4 shows that modeling and quantitatively measuring a client investor-user's preferences as context specific risk preferences of a subject investment/asset requires additional structure and function be given to a client computer system 50, 50a.

Currently, in practice, the strategy used for making financial recommendations is the ‘all-things-being-equal strategy’, for which client-users are asked only to provide the kind of ranking of preferences seen in step 403 of the logic diagram. The preferred non-financial characteristics are then maximized subject to a constraint that the return and volatility of the portfolio match some benchmark. In contrast, Applicant's method requires investment recommendations based on derivations from the mathematical form of a utility function that allows for each investment to have a different risk-aversion based on the non-financial characteristics of the assets. In other embodiments, a single numerical value for a client's risk-aversion is computed for each candidate portfolio instead of a different risk-aversion value for each asset. In the simplest embodiment, one uses an exponential utility u (Equation 2) for a client investor-user with an asset specific risk-aversion computed from the generic context-specific risk-aversion that was measured by the client computer system 50, 50a:

u=1−e^{-W}^{₀}^{Σ}^{ᵢ₌₁}^{^{N}}^{γ}^{ᵢ}^{w}^{ᵢ}^{r}^{ᵢ} Equation 2

Where u is utility of the investor,
i is an index that runs over the N assets being invested in,
γᵢ is risk aversion function for each asset, which is a function of the non-financial characteristics gᵢ of the asset, i.e. γᵢ=γ(gᵢ),
wᵢ is a weight for relative amount invested in the asset, and
rᵢ is financial return of the asset.

From equation 2, one skilled in the art can derive an equation for the composition of the financial investment that would maximize the investor's expected utility (Equation 3), or similar variants and approximations. In Applicant's disclosure, the sole motive for investment is the total financial return of the financial investment; the non-financial characteristics are not outcomes of the decision that make the optimization problem, but form the context under which a decision is made. In other words, the decision is modeled as a multivariable (through risk-aversion) but is a univariate decision problem. Following derivatives of the expected utility of Equation 2 with Gaussian returns, one obtains a modified mean-variance optimization problem for asset i of the form of Equation 3:

$${w}_{opt} = arg {max}_{w} {\sum }_{i = 1}^{N} {μ}_{i} {γ}_{i} {w}_{i} - \frac{1}{2} {\sum }_{i , j = 1}^{N} {w}_{i} {γ}_{i} {σ}_{i j} {γ}_{j} {w}_{j} \qquad Equation 3$$

$${w}_{opt} = arg {min}_{w} \frac{1}{2} {\sum }_{i , j = 1}^{N} ( {w}_{i} - {b}_{i} ) {γ}_{i} {σ}_{i j} {γ}_{j} ( {w}_{j} - {b}_{j} ) \qquad Equation 4$$

Where μᵢ is the mean return of the asset,
i and j are indices that runs over the N assets being invested in,
σᵢⱼ is the covariance of the returns between asset i and j,
γᵢ is risk aversion function for each asset, which is a function of the non-financial characteristics gᵢ of the asset i, i.e. γᵢ=γ(gᵢ),
wᵢ is a weight for percent amount invested in the asset i, and
bᵢ is a weight for percent amount of asset i in a benchnark.
   A person skilled in the art would recognize that the relationship between the risk-aversion parameter and the data transmitted by the client computer system 50 on the client investor-user's risk premium can be derived analytically from the utility function u in Equation 2.

In the absence of any constraints, solutions to the optimization problem of Equation 3 can be analytically derived, which corresponds to a multiplicative scaling of the un-normalized weights from standard mean variance, where the tilt factor is the inverse of the fractional change in risk-aversion. In practice, substantial constraints need to be added to Equation 3 to obtain financial investment recommendations that perform well empirically. In the presence of constraints (such as a long-only constraint, a no leverage constraint, transaction cost constraints, a target volatility or return, tracking error constraints), solutions to the portfolio allocation problem, and computation of financial investment recommendations need to be found algorithmically on a server system 60. However, the analytic solution demonstrates that indeed, Equation 3 tilts financial investments to take risks and participate in those assets that align with their personal integrity values. Individuals generally exhibit higher risk-tolerance when lotteries/assets align with their personal integrity values, and this higher risk-tolerance means that, all things being equal, an individual has a preference for taking risks on investment opportunities that align with their personal integrity values (i.e., social, moral, religious, political, and the like). Strategies in the art for all-things-being-equal typically involves maximizing non-financial characteristics subject with an equal return constraint and a tracking error constraint. The tracking error determines the maximum deviation from a benchmark for a client investor-user (such as the S&P500 or Russell 1000 for the United States). Benchmark tracking indices are used both for direct indexing (personalizing the portfolios of client investors) and for managing investment funds (such as an ETF), and one of the major types of financial investments that the computer systems and methods herein can provide. In the context-specific risk-aversion model, however, changes in non-financial characteristics do not arise from maximizing them, but rather from minimizing the context-specific risk-aversion based risk-premium (Equation 4), subject to the same equal returns and tracking error. This further shows that personal values investing using a context-specific risk-aversion has a sole motive of financial gain. More broadly, the financial investment recommendations are also recommendations for actions taken for financial gain that preserve a person's personal integrity values (social, moral, and other non-financial transactional views), and are made using quantitative computations implemented with computer systems and methods.

A person skilled in the art of portfolio optimization or scoring of financial securities (investments generally) will recognize that embodiments of the present invention are not limited to the modified mean-variance Equation 3 above. Upon careful modification to reflect a context-specific risk aversion instead of a scalar risk-aversion, the model of investor (client investor user) utility u (Equation 2), for example, can be, but is not limited to, any of the following: quadratic utility, exponential utility, hyperbolic utility, power utility, and a utility function from prospect theory (loss averse). When recommending financial securities, one way of improving financial investment recommendations is for an investment professional to use their expert/private/proprietary views to make active predictions on the future returns of assets, in such embodiments the server system 60 can be configured to provide recommendations using a variation of Black-Litterman equations. Another method a person skilled in the art may use is to use a more empirically accurate (non-Gaussian) probability distributions for the future returns of assets, in which case there may not be a closed analytic form for expected utility as in Equation 3, and in such embodiments the server system 60 would be configured to solve the problem with Monte-Carlo simulations. Private views and non-Gaussian returns may sometimes be combined, and in such embodiments the server system 60 can provide recommendations using a variant of the Fully Flexible Views method. See A. Meucci, “Fully Flexible Views: Theory and Practice,” Risk, 21 (10), pg. 97-102 (2008). From this discussion, a person skilled in the art would also recognize that the method of incorporating risk-aversion based preferences for non-financial characteristics is independent of, and complementary to, the probability distribution of returns.

Primarily owing to the fact that the actual future performances of assets is unknown and are very imperfectly estimated by historical estimates, those skilled in the art often modify mean variance equations with additional mathematical terms. These terms do not originate from the analytically deriving the form of the utility function, but are rather used based on experimental evidence that their addition can improve the financial performance of investments. The general form of the modified mean-variance equation is often described as minimizing a risk-measure minus the expected returns of the portfolio. A large number of risk-measures—including but not limited to combinations of the variance, Rao's Quadratic Entropy, Shannon's Entropy, Risk Budgeting and Risk Parity Strategies, conditional variance under risk, robustness terms — can be modified with a context-specific risk-aversion that is computed for all assets that the financial investment is composed of.

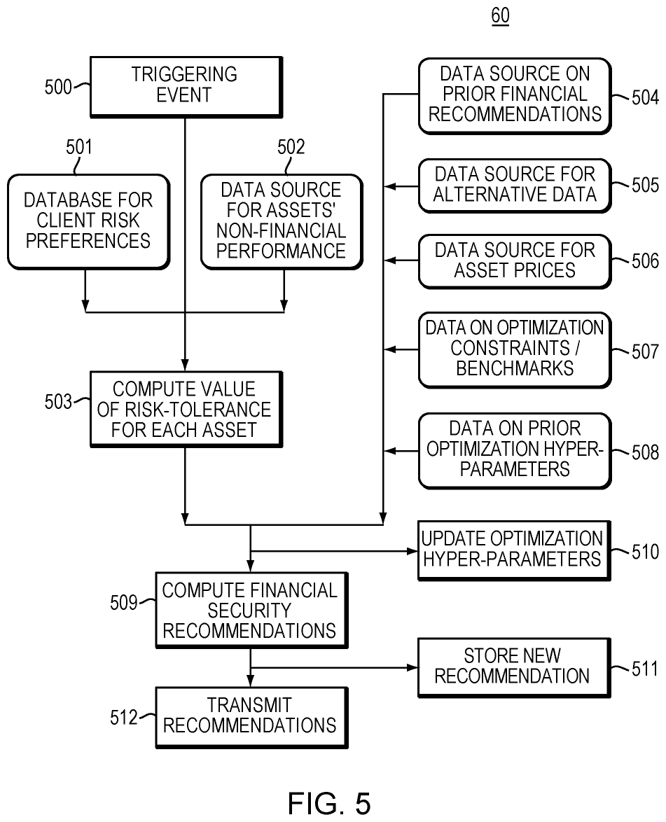

In an embodiment, the software program, procedure, or routine used by the server system 60 for recommending the composition (percentage allocations in a list of actual assets) of a portfolio (financial investment more generally) is presented in FIG. 5. Upon receipt of a triggering event 500 by the server system 60, the server system commences the processes of producing a new, or updating an existing, financial or investment recommendation. The triggering event 500 can be a request from the client system 50 (such as investor user information at 50a or service/investment provider end user at 50b advising an individual of interest), or a signal from a communicatively coupled computer system indicating a change in some data tracked by the server system 60. Using a client investor-user identifier, the server system 60 retrieves data encoding the client investor-user's context-specific risk preferences from a communicatively coupled memory store 501 as well as data representing the non-financial characteristics 502 of hypothetical and/or actual assets, and uses them to compute (at 503) a risk-aversion for each actual (market available) candidate asset according to the above details of Equation 2. In some embodiments, the asset level risk-aversion 503 can itself can be stored from a previous computation if there are no changes in the data sources used for its calculation. In other embodiments, the individual of interest does not have measurement data of context-specific risk aversion stored in data store 94 but effectively identifies with the one or more investor-users who do have such context-specific risk aversion measurements stored in system 1000.

Then, the server system 60 retrieves data on any prior financial or investment recommendations (if present) from communicatively coupled memory store(s) 504, alternative data sources (such as news or sentiment, optional if used by person skilled in the art) 505, the prior prices of actual assets 506, relevant constraints and benchmarks for the optimization 507, and prior hyperparameters (if present) used in the optimization problem 508. A person skilled in the art would understand that there are a large variety of methods for constructing the optimization problem, and not all data sources are needed for the server system 60 in embodiments described (nor are embodiments limited to any particular data source). A person skilled in the art would also recognize that the forgoing data 504, 505, 506, 507, 508 need not be stored on different (or the same) memory stores, and that the data can be retrieved from a variety of different types of communicatively coupled memory stores ranging from databases located on the same server computer 60 to third party APIs that the server computer 60 fetches data from.

With the relevant data, a computational algorithm (e.g., Equation 3) on the server system 60 finds the weights of a stock portfolio (or investment portfolio) that maximizes the expected utility for the client investor-user (or individual of interest) at 509, and if relevant also computes required updates in optimization hyperparameters 510. The resulting financial investment recommendations (on actual investments) are then saved in the relevant communicatively coupled data store 511 and at 512 transmitted to the client system 50 (including client processor 50a of an investor -user, and processor 50b of an investment provider end-user) via communication links, network communication protocols, etc. In other embodiments, when only a single risk-aversion is computed for the entire investment (instead of each underlying asset composing the investment security), then the computation of a portfolio level (instead of individual asset level) risk aversion 503 is a sub-step (and not a preceding step) of the optimization calculation (of Equation 3) 509 of the financial security. Also consistent with the disclosed computer system 1000 is the use of a single risk-aversion parameter, γ({wᵢ,gᵢ}) that is a function of the non-financial characteristics gᵢ of each asset i as well as the weights wᵢ of each asset in the aggregate security (or investment). The use of such a risk-aversion parameter makes the optimization problem possibly non-convex in the weights of the financial security, and therefore additional care must be taken.

In practical applications, the composition of financial portfolios is a broad term including but not limited to: stock portfolio, a benchmark-tracking personalized portfolio, a personalized ESG index, a personalized ESG benchmark tracking index, and direct indexing. In other embodiments, the composition of a financial portfolio can be computed using the measurement data of a plurality of client investor-users. The use of the measurement data from a plurality of investor-users is useful in providing recommendations on the compositions of financial funds—such as but not limited to exchange traded funds (ETFs), mutual funds, and pension plan funds—in which plurality of individuals with varied context-specific risk-aversion share the same investment composition. In the case of providing recommendations on the composition of investment funds with multiple investors, the client investor-users whose data is used to compute the recommendation may be different from the actual investors in the fund. Further the investments in the computed recommendations may differ (are separate and distinct) from the investments used in generating the measurement data (context-specific risk aversions) stored in datastore 94. In other embodiments, the same investments used in generating the context-specific risk aversion measurement data is included in the server computed recommendations.

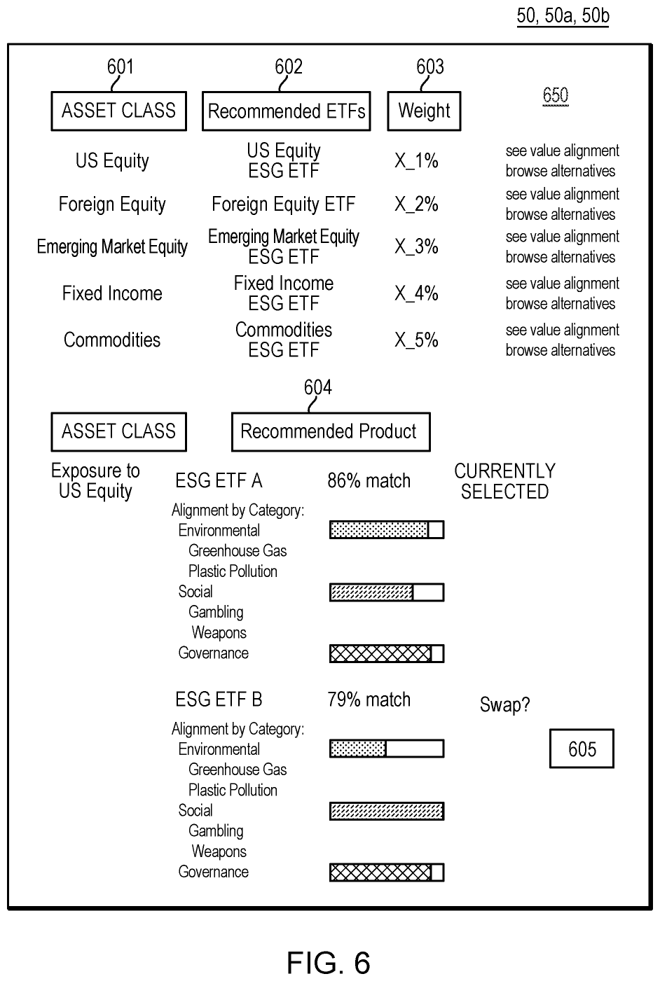

A person skilled in the art will recognize that financial security recommendations are not limited to optimizing the composition of a portfolio (set of actual investments). By quantitatively measuring risk-preferences of an individual (a client user, or investor), and how the measured risk preferences aggregate, it becomes possible to compute a numerical score (for example, the value of Equation 3) that describes how well suited any financial security (actual financial investment) is for the individual investor-user or for those who effectively identify with the same context-specific risk aversions. One problem often faced by individuals is the vast number of financial securities between which they must choose to invest. Having a method to score financial investments based on preferences for non-financial characteristics makes it is possible to rank (order/sort) financial investments that have the highest risk-return characteristics in a way that is also consistent with the client investor-user's preferences. In one embodiment, the server system 60 can compute a numerical score across a range of existing financial investments (for example, by plugging into the weights of the assets composing the financial investments into Equation 3), and transmit back to the client system 50 (e.g., investor-user processor 50a, and investment/service provider end-user processor 50b) a ranking of those financial securities based on the numerical score. The client-side user can then use those scores to construct a holding of actual assets. An embodiment of the client interface (e.g., screen view) 650 presenting the ranked financial investments for constructing a long-term portfolio is provided in FIG. 6. In the described embodiment, the recommendation system 1000 client side 50 recommends the client-side user (e.g., individual investor-user, and/or investment service provider end-user) to build a diversified portfolio by investing in several ETFs spanning a number of asset classes and geographic regions chosen to provide sufficient diversification 601. For each class of assets listed in 601, the computer system 1000 can be further used to produce: (a) a recommended financial investment 602, and (b) the percent 603 of total funds that the client-side user should allocate to the recommended financial investment (assets) in each (asset) class. The server system 60 also transmits the aggregate numerical score 604 of the financial (investment) recommendations, and a breakdown of the score for each of the categories over which the client investor-user has provided data on their risk-preference. In addition, the server system 60 transmits the same information for N-highest ranking financial securities so that a client-side user has the option of overriding the recommendation by pressing a button 605 on the interface screen view. In other embodiments, the financial investment recommendations can take the form of a stock portfolio, or a personalized index; where associated with a client identifier, it becomes possible to sell the financial securities to the client investor-user, whether directly or through a third party.

In another embodiment, the financial recommendations can be recommendations on how a shareholder, or a proxy for one or a plurality of shareholders in a company should vote on a shareholder resolution based upon the context-specific risk-aversion of the one or plurality of shareholders. In another embodiment, the financial recommendations can be recommendations on which projects/policies/lines of business corporate management should pursue given the context-specific risk-aversions of their shareholders. In other embodiments, the financial recommendations can be in the form of interest rate index that benchmarks what interest rate loans or bonds should be issued at given the non-financial characteristics of the borrower or bond issuer.

As mentioned above, upon receipt of the produced financial investment recommendations, end-user processors 50b (or subsequently server 60 in response to investor-user command) may implement an investment transaction, i.e., execute purchase of a recommended investment. Such automatic purchasing or transaction mechanisms as existing in the art may be employed. For non-limiting example, Index providers that provide recommendations for automatic execution of transactions include: MSCI, S&P Dow Jones Global, and FTSE Russell. Financial Institutions have computer systems configured to receive recommendations (indices) from these companies and automate trading actions based on those recommendations. Embodiments of the present invention may similarly provide recommendations to preconfigured financial institutions for executing automatic trading actions based on the recommendations. In another example, Direct Index Providers (ESG) that provide recommendations for automatic execution of transactions include Aperio, Openlnvest, and Ethic. Registered Investment Advisors and Financial Institutions use the services of these companies to provide clients with personalized index (direct index) that better meets their ESG preferences. The software automating the transactions may be incorporated or interfaced with embodiments of the present invention. In a further example, brokerages with APIs for execution of transactions by retail investors or their authorized proxies may be employed by embodiments. Brokerages like Robinhood, Alpaca, and TDAmeritrade provide APIs so that calling the API can directly execute trades.

### Computer Support

FIG. 7 illustrates a computer network or similar digital processing environment in which embodiments of the present invention may be implemented.

Client computer(s)/devices 50, 50a, 50b and server computer(s) 60 provide processing, storage, and input/output devices executing application programs and the like. Client computer(s)/devices 50, 50a, 50b can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

FIG. 8 is a block diagram of the internal structure of a computer (e.g., client processor/device 50, 50a, 50b or server computers 60) in the computer system of FIG. 7. As used and described herein, general references to client processor/device 50 includes client processors 50a, 50b. For example, the following description of FIG. 8 applies to client processors 50a, 50b (indicated for ease of the forgoing discussion of the various client-side users) as well as to client processors 50 in general. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 7). Memory 90 provides volatile storage for computer software instructions 92 and data 94 used to implement an embodiment of the present invention (e.g., the recommendation method, system, techniques, program code and interface measuring context-sensitivity of risk aversion detailed above in FIGS. 1 through 6). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In other embodiments, the program product 92 may be implemented as a so called Software as a Service (SaaS), or other installation or communication supporting end-users.

While example embodiments have been particularly shown and described, it will be understood by those skilled in the art that various changes in form and details may be made therein without departing from the scope of the embodiments encompassed by the appended claims.

What is claimed is:

1. A computer-based system that recommends financial investments, comprising:
a client processor interactively obtaining from a user context-specific risk-aversion for a subject investment by soliciting interactive input from the user in a manner producing quantitative measurement data that encodes the user's risk-aversion toward variable financial outcomes of the subject investment and the non-financial characteristics serving as contextual information that modulated the user's interactive input about the subject investment; and
a data storage feed forwarding the produced measurement data from the client processor to a datastore in computer memory communicatively coupled to receive the measurement data encoding both the user's risk-aversion and the contextual information about the subject investment, the datastore holding measurement data of one or more users and their risk-aversion and respective contextual information for respective subject investments in a manner enabling computing of one or more financial investment recommendations consistent with the user's context-specific risk aversion.

2. The computer-based recommendation system as claimed in claim 1 wherein the client processor includes a graphical user interface that interactively obtains from the user the context-specific risk-aversion, the graphical user interface presenting information regarding the subject investment's variable financial outcomes alongside the contextual information regarding the non-financial characteristics of the subject investment, and the user input being in response to the presented information; and
wherein the quantitative measurement data is produced from the responsive user input to the graphical user interface and encodes the user's risk-aversion toward the subject investment's variable financial outcomes and the contextual information.

3. The computer-based recommendation system as claimed in claim 2 wherein the graphical user interface presents to the user the variable financial outcomes as any of:
a) a scenario of a financial loss alongside a scenario of a financial gain; and
b) a computed statistic of a loss and a computed statistic of a gain.

4. The computer-based recommendation system as claimed in claim 2 wherein the user input corresponds to an amount of money they would be willing to pay to accept the variable financial outcomes of the subject investment.

5. The computer-based recommendation system as claimed in claim 2 wherein the graphical user interface presents to the user two subject investments with either or both respective variable financial outcomes or non-financial characteristics being different, and wherein the responsive user input is indicative of their preference between the two subject investments.

6. The computer-based recommendation system as claimed in claim 2 wherein the graphical user interface displays benchmarking information alongside an input field receiving the user input, the benchmarking information including any one or more of:
a) data from a previous input from the user,
b) a value representation of the user input corresponding to certain goals or targets being met,
c) indications of context-specific risk-aversion of other individuals in similar contexts, and
d) information revealed to the user following input that represents a completion of an anticipated event such as outcome of a bidding process and the like.

7. The computer-based recommendation system as claimed in claim 2 further comprising:
the data storage feed being coupled between the client processor and a server computer, the server computer coupled to receive from the data storage feed the measurement data from the client processor, the server computer storing the received measurement data in the datastore, and the server computer computing the one or more financial investment recommendations consistent with the user's context-specific risk aversion; and
one or more end-user processors receiving from the server computer relationship the computed one or more financial investment recommendations as indicative of relationships between the one or more users and their context-specific risk aversions, the one or more end-user processors receiving the computed financial investment recommendations in a manner supporting execution of a purchase of one of the recommended financial investments on behalf of the user or on behalf of one who effectively identifies with the user's context-specific risk aversion.

8. The computer-based recommendation system as claimed in claim 7 wherein the client processor receives from the server computer the computed financial investment recommendations and displays the recommendations in the graphical user interface to the user.

9. The computer-based recommendation system as claimed in claim 7 wherein the one who effectively identifies with the user's context-specific risk aversion is separate and distinct from each user of the one or more users.

10. The computer-based recommendation system as claimed in claim 7 wherein the computed one or more financial investment recommendations comprise any one or combination of:
a) a ranking or ordering of existing financial investments based on the measurement data of one or more users;
b) a composition of a financial index for the one or more users comprising information encoding percentages allocations to invest in a plurality of underlying financial assets based on the measurement data of the one or more users;
c) a composition of an investment vehicle in which multiple investors share a same asset allocation, comprising information encoding percentages allocations to invest in a plurality of underlying financial assets based upon the measurement data of the one or more users;
d) a benchmark interest rate index that specifies an interest rate at which monies should be lent to a party based on non-financial characteristics of said party;
e) a vote on a proposal regarding a management decision in a shareholder meeting; and
f) a recommendation on an investment decision taken by corporate management.

11. The computer-based recommendation system as claimed in claim 7 further comprising a transaction mechanism communicatively coupled to the client processor or to the server computer enabling execution of a purchase of one of the recommended financial investments on behalf of the user.

12. The computer-based recommendation system as claimed in claim 7 wherein the server computer computes the one or more financial investment recommendations using an algorithm with any one or a combination of:
a mean financial return of a portfolio, including factor-based decompositions thereof;
terms that are quadratic in variances or covariances of financial returns, each term being multiplied by a context specific risk-aversion factor;
terms that regularize variances or covariances such as shrinkage, or Rao's entropy;
terms that regularize variances or covariances that have a bias term that depends on the context-specific risk-aversion factor in a financial investment;
an entropic term that is modified by the context-specific risk-aversion factor;
worst-case risk-measures, such as variance at risk or conditional variance at risk that are modified by the context-specific risk-aversion factor;
forms of Risk-parity, risk-budgeting, or hierarchical risk-budgeting that are modified based on the context-specific risk-aversion factor;
terms that account for transaction costs of updating the weights of a financial investment; and
terms that account for market impact costs when updating weights of a financial investment.

13. The computer-based recommendation system as claimed in claim 7 wherein the computed one or more financial investment recommendations are updated or rebalanced over time, including in response to:
additional preference data transmitted by the client processor through the data storage feed;
changes in environmental, social, or governance (ESG) ratings data;
changes in market prices;
passage of a fixed time interval;
news events; and
computer analysis of a time varying input data source.

14. The computer-based recommendation system as claimed in claim 1 wherein the subject investment is any of: a hypothetical investment, an actual investment, and a combination of hypothetical and actual investments.

15. The computer-based recommendation system as claimed in claim 1 wherein the computed one or more financial investment recommendations are directed to financial investments that are distinct from the subject investment.

16. The computer-based recommendation system as claimed in claim 1 wherein the computed one or more financial investment recommendations are directed to financial investments that include the subject investment.

17. A computer-implemented recommendation system comprising:
a datastore in computer memory holding quantitative measurement data of one or more users, for each user, the quantitative measurement data of the user encodes both (a) risk-aversion of the user toward variable financial outcomes of a respective subject investment and (b) non-financial characteristics serving as contextual information about the subject investment, and the quantitative measurement data being produced from user interactive input with respect to the subject investment, for different users, the datastore holding measurement data encoding the user's risk aversion with respective context information of different subject investments; and
a server computer coupled to access the datastore, and using the quantitative measurement data of the one or more users, the server computer computing one or more financial investment recommendations consistent with any part of the one or more users' context-specific risk aversions, and the server computer supporting transmission of the computed one or more financial investment recommendations in a manner enabling execution of a purchase of one recommended financial investment in the computed one or more financial investment recommendations on behalf of an investor-user of the one or more users or on behalf of a person who effectively identifies with a context-specific risk aversion supporting the computed recommendations, the person being distinct from the one or more users.

18. The computer-based recommendation system as claimed in claim 17 wherein the datastore further supports various types of data in conjunction with the quantitative measurement data of the one or more users to generate financial investment recommendations, the various types of data including any one or combination of:
asset price distribution data, where the distribution data encodes information about probability distribution of asset prices;
non-financial characteristics data, where said data encodes information about the historical, present, or future expected values or probability distributions of non-financial characteristics of assets that a financial investment is to be composed of;
future distribution data, where the future distribution data encodes information about future distribution of asset prices or about future distribution of non-financial characteristics;
alternative data sources, including any of: expert views, proprietary data, news data or sentiment analysis data;
constraint data, where constraint data encodes information about what constraints are to be imposed upon optimization;
benchmark data, where benchmark data encodes a reference for which assets can be considered as part of a financial investment or encodes a reference for asset allocation of a financial investment;
hyperparameter data, including parameters used for regularizing asset price distributions, for handling transaction; and
machine learning model data, where the server employs a neural network to compute any financial investment recommendation.

19. The recommendation system of claim 17 further comprising a data source feed between the datastore and a client processor, the client processor having a graphical user interface that interactively obtains, from the investor-user of the one or more users, context-specific risk-aversion of the respective subject investment by soliciting input from the investor-user in a manner producing the quantitative measurement data; and the data source feed carrying the produced quantitative measurement data from the client processor to the datastore for storage.

20. The recommendation system of claim 19 wherein the graphical user interface presents to the investor-user information regarding the subject investment's variable financial outcomes alongside the contextual information regarding the non-financial characteristics of the subject investment, and the user input is by the investor-user responding to the graphical user interface presented information.

21. The recommendation system of claim 19 wherein in the server computer's computations, the risk-aversion of the investor-user is encoded as a non-constant risk-aversion function of one or multiple non-financial variables that can be mapped to (i) a numerical value for any single financial asset, or (ii) a numerical value for a subset of financial assets that is used as a constituent in a candidate financial investment for recommendation.

22. The recommendation system of claim 17 wherein the server computer computes numerical values of a risk-aversion function from data on non-financial performances of underlying assets in addition to the quantitative measurement data held in the datastore.

23. The recommendation system as claimed in claim 17 wherein the server computer further supports transmission of the computed one or more financial investment recommendations in one or a combination of: (a) a manner enabling display of the recommendations to any one or combination of the investor-user and other end users, and (b) a manner enabling a financial institution to update an investment portfolio.

24. The recommendation system as claimed in claim 17 wherein the subject investment is any of: a hypothetical investment, an actual investment, and a combination of hypothetical and actual investments.

25. The recommendation system as claimed in claim 17 wherein the computed one or more financial investment recommendations are directed to financial investments that are distinct from subject investments used to produce the quantitative measurement data of the investor-user.

26. The recommendation system as claimed in claim 17 further comprising:
an end-user processor of an investment provider coupled to receive from the server computer the computed one or more financial investment recommendations, and the end-user processor responsively executes a purchase of the one recommended financial investment on behalf of the investor-user or on behalf of the person.
